(19) United States
(12) Patent Application Publication
(10) Pub. No.: US 2006/0077490 A1
(43) Pub. Date: Apr. 13, 2006

(54) Automatic adaptive gamma correction

(76) Inventors: Semion M. Sheraizin, Mazkeret Batya (IL); Vitaly S. Sheraizin, Mazkeret Batya (IL)

Correspondence Address: DANIEL J SWIRSKY, 55 REUVEN ST., BEIT SHEMESH, 99544, IL

(21) Appl. No.: 10/889,221

(22) Filed: Jul. 13, 2004

(51) Int. Cl. G03F 3/08

(52) U.S. Cl. 358/519

(57) ABSTRACT

A system includes an image analyzer to analyze an input image to generate correction parameters and a grey scale stretcher to utilize said correction parameters to perform a grey scale stretch on the image with little or no visible change in the noise level of the image.

### FIELD OF THE INVENTION

The present invention relates to still image processing generally and to automatic gamma correction in particular.

### BACKGROUND OF THE INVENTION

Digital images are common and are produced by many different entities. Some are produced by professional photographers but many are generated by amateurs. The latter are often shot with little thought to the composition of the photograph and thus, the resultant photograph may not look as beautiful as possible. A common error is misuse of lighting such that the photograph is too dark, too light or unevenly lit This error can be fixed through a technique known as “gamma (γ) correction”, which stretches the grey scale or dynamic range of the photograph.

A common gamma correction graph is shown in FIG. 1, to which reference is now made. Gamma correction changes an input intensity level Vᵢ, normalized by the maximum intensity level Vₘₐₓ of the image, (the X axis), into an output intensity level Vᵢ, normalized by the maximum intensity level Vₘₐₓ of the image (the Y axis). If γ is 1 (the graph labeled 10), then there is no correction and the output is the same as the input. This is used for a normal looking image. If the image is dark, the image needs to be lightened and the output intensities should be raised. Thus, γ is set to less than 1. FIG. 1 shows, in graph 12, the curve for γ=0.5. If the image is light, the image needs to be darkened and the output intensities should be lowered. Thus, y is set to greater than 1. FIG. 1 shows, in graph 14, the curve for γ=2.

Unfortunately, gamma correction takes a professional eye to choose the proper level of γ to fix the photograph

### BRIEF DESCRIPTION OF THE DRAWINGS

The subject matter regarded as the invention is particularly pointed out and distinctly claimed in the concluding portion of the specification. The invention, however, both as to the principle algorithm and method of operation, together with objects, features, and advantages thereof, may best be understood by reference to the following detailed description when read with the accompanying drawings in which:

FIG. 1 is graphical illustration of a gamma correction operation;

FIG. 2 is a block diagram illustration of an image improver, constructed and operative in accordance with the present invention;

FIG. 3 is a graphical illustration of high pass and low pass filter operations, useful in the image improver of FIG. 2;

FIG. 4 is a graphical illustration of a multiplicity of exemplary histograms, useful in understanding the operation of the image improver of FIG. 2;

FIG. 5 is a block diagram illustration of a parameter generator forming part of the image improver of FIG. 2;

FIG. 6 is a graphical illustration of gamma correction implemented in the image improver of FIG. 2;

FIG. 7 is a block diagram illustration of a gamma processed data adaptive noise reducer forming part of the image improver of FIG. 2;

FIG. 8 is a block diagram illustration of a small details adaptive noise reducer forming part of the image improver of FIG. 2;

FIGS. 9A and 9B are graphical illustrations of exemplary histograms, useful in understanding a second embodiment of the present invention; and

FIG. 10 is a block diagram illustration of a second embodiment of the image improver of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention may improve improperly exposed images and may do so automatically, with no need for user (professional or otherwise) participation. Moreover, the processing may do so with little or no increase in visible noise. The method of the present invention may be applied to all types of digital images, such as those from a digital still camera, printers digital video, internet video, etc.

Applicants have realized that gamma correction performed on the entire image does not produce the nicest possible image. In accordance with a preferred embodiment of the present invention, the correction performed on the elements which a viewer may perceive, such as small details and their contrast, may be different than the correction performed on the background of the image or on large details. Moreover, in accordance with a preferred embodiment of the present invention, the grey scale stretch may be provided with little or no visible change in noise level of the image.

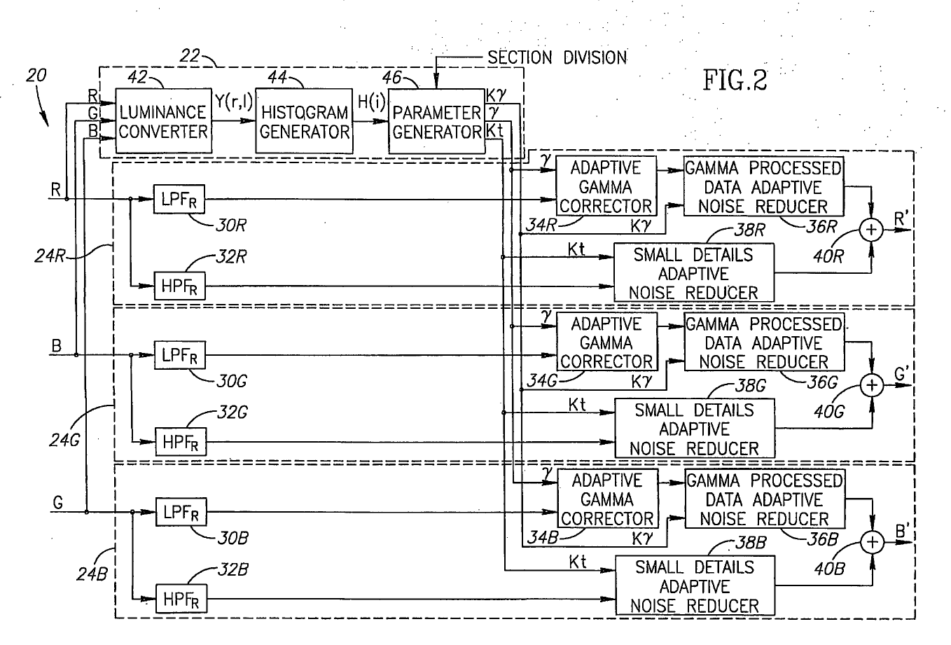

Reference is now made to FIG. 2, which illustrates one embodiment of an automatic image improver 20, constructed and operative in accordance with the present invention. Image improver 20 comprises a picture parameter determiner 22, and a plurality of color component improvers 24, one per color component In the embodiment of FIG. 2, the color components are red, green and blue (R, G, B) and there are three color component improvers 24R, 24G and 24B, respectively.

Each color component improver 24 may comprise a low pass filter (LPF) 30, a high pass filter (HPF) 32, an adaptive gamma corrector 34, a gamma processed data adaptive noise reducer 36, a small details adaptive noise reducer 38 and an adder 40. The elements of color component improver 24R processing the red color component are labeled with an R, those of color component improver 24B are labeled with a B and those of color component improver 24G are labeled with a G.

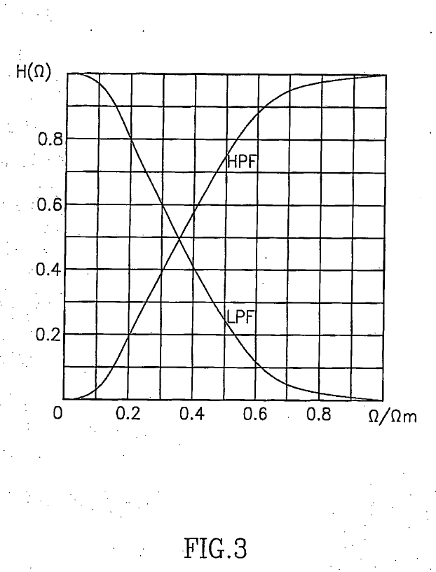

Color component improver 24 may utilize LPF 30 and BPF 32 to separate its component signal into two channels, one for large details and one for small details, respectively, and may process each channel separately. FIG. 3, to which reference is now briefly made, is a graphical illustration of exemplary high and low pass filters, useful in the present invention. Their cutoff frequencies are set at the expected size of the largest small detail (e.g. 4 pixels).

In accordance with a preferred embodiment of the present invention, the small details (generated by HPF 32) may be processed by noise reducer 38. This may reduce the noise on the small sized details that people perceive less than large details and may thus provide a sharper looking image.

Applicants have real that the exposure of large details may affect the image more than the exposure of small details and that gamma correction on such large details may have a greater effect on the overall image. Thus, in accordance with a preferred embodiment of the present invention, color component improver 24 may pass the large details, generated by LPF 30, through gamma corrector 34. Since, as Applicants have realized, gamma correction may generate noise, the output of gamma corrector 34 may be processed by gamma noise corrector 36 to minimize the noise added by gamma corrector 34.

The output of the two channels may be combined together by adder 40 to generate the improved color component signal. Thus, if the color component being processed is the red component, the output may be the improved color component R′.

In accordance with a preferred embodiment of the present invention, the parameters for gamma corrector 34, gamma noise reducer 36 and small details noise reducer 38 are a function of the details in an input image, such as a digital image or a digitized analog image. Parameter determiner 22 may analyze the input image and may determine the gamma γ level to correct the large details of the input image. Parameter determiner 22 may also determine a gamma noise coefficient K_{γ} and a small details noise coefficient Kₜ. Parameter determiner 22 may provide gamma γ to gamma correctors 34, gamma noise coefficient K_{γ} to gamma noise reducers 36, and small details noise coefficient Kₜ to small details noise reducer 38.

Parameter determiner 22 may comprise a luminance converter 42, a histogram generator 44 and a parameter generator 46. Converter 42 may convert the input RGB signal to a luminance value Y. Such a conversion is known in the art One exemplary well-used conversion equation is:
Y=0.3R+0.59G+0.11B

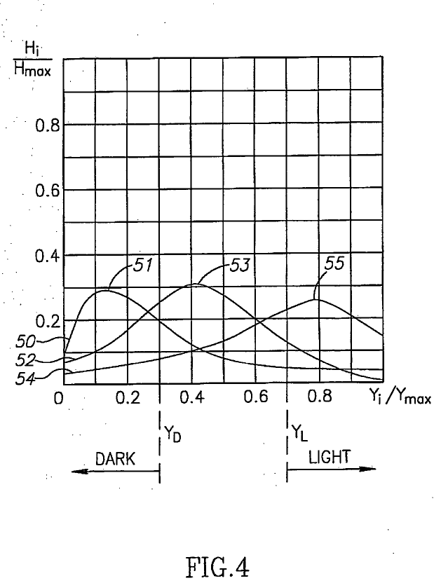

Histogram generator 44 may generate a histogram H of luminance Y in the input image. Histogram is a graph of pixel quantity H(Yᵢ) (i.e. the number of pixels in the input image for every luminance level Yᵢ) in the input image. Reference is now made to FIG. 4, which illustrates some exemplary histograms, where the X axis is the normalized intensity Yᵢ/Yₘₐₓ, and the Y axis is the normalized histogram Hᵢ/Hₘₐₓ. Yₘₐₓ. may be the maximum allowable value of the intensity, such as 255, and Hₘₐₓ may be the maximum number of pixels in the image.

In curve 50, the histogram has a peak 51 in the lower intensities, indicating a dark image. Curve 52 graphs the histogram for a normal image, with a peak 53 in the middle range of FIG. 4. Finally, curve 54 has a peak in the brighter intensities, indicating a generally much too light image.

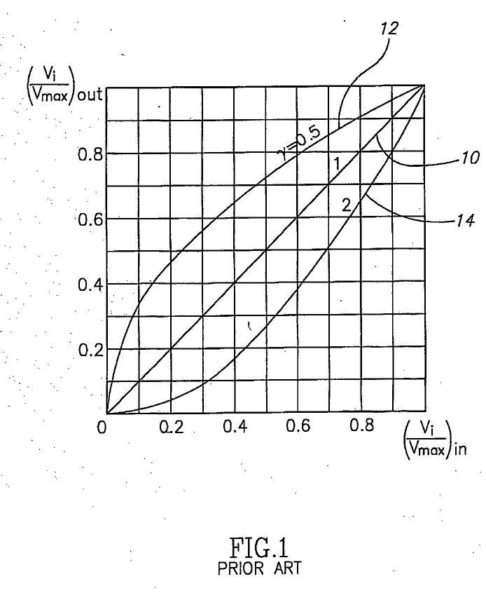

In accordance with a preferred embodiment of the present invention, parameter generator 46 (FIG. 1) may divide the histogram graph into sections of different exposure quality. For example, three sections, for light, dark and normal exposures, may be defined. Alternatively, more sections, for more refined processing, may be defined. The definition may be done by a designer and may involve selecting the intensity levels (Yᵢ/Yₘₐₓ) defining the borders between sections. For the three section example, the borders might be Y_{D}=0.3Yₘₐₓ and Y_{L}=0.7Yₘₐₓ. These borders are marked on FIG. 4. The dark section may thus be the portion of the graph with intensity levels below Y_{D}, the light section may be the portion of the graph with intensity levels above Y_{L} and the normal section may be between the borders Y_{D} and Y_{L}.

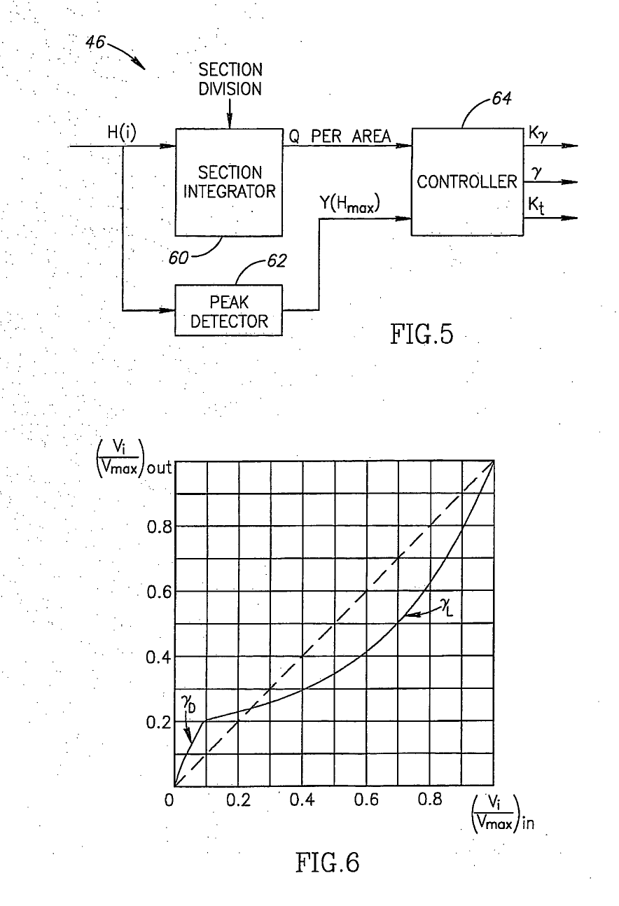

As illustrated in FIG. 5, to which reference is now made, parameter generator 46 may comprise a section integrator 60, a peak detector 62 and a controller 64. Section integrator 60 may determine the quantity Q of pixels per section, as defined by the section division. The integration may involve summing the histogram values for the intensities in the relevant section. For the three section example, the equations may read:

$${Q}_{D} = {\sum }_{0}^{{Y}_{D}} H ( {Y}_{1} )$$

$${Q}_{N} = {\sum }_{{Y}_{D}}^{{Y}_{L}} H ( {Y}_{1} )$$

$${Q}_{L} = {\sum }_{{Y}_{L}}^{{Y}_{max}} H ( {Y}_{1} )$$

Peak detector 62 may be any suitable peak detector, of which many are known in the art. In particular, peak detector 62 may find where H, the point where the histogram H is at its maximum, and Y(Hₘₐₓ), the intensity Y at the maximum point Hₘₐₓ.

Controller 64 may determine which type of exposure the input image has, in one of a number of ways. In one embodiment, controller 64 may select the section which has the largest quantity value. In another embodiment, controller 64 may have threshold values set for the dark and light sections. Thus, an image may be determined to be dark only if the dark quantity Q_{D} may be greater than a threshold, defined as a percentage of the total number Q_{M} of pixels in the image. Thus, only if Q_{D}>q_{D}*Q_{M}, where q_{D} may be, for example, between 50% and 100%, may controller 64 determine that the input image has a dark exposure. Similarly for a light exposure. If Q_{L}>q_{L}*Q_{M}, where q_{L} may be, for example, between 50% and 100%, may controller 64 determine that the input image has a light exposure.

In either embodiment, once controller 64 has determined the type of exposure in the input image, controller 64 may determine the gamma γ level. If the exposure is normal, γ_{NP} may be
γ_{NP}=1

Otherwise, for both dark and light exposures, the gamma γ level may be defined as:

$${γ}_{D} = {γ}_{L} = {γ}_{0} + {K}_{G} \frac{Y ( {H}_{max} )}{{Y}_{max}}$$

where γ₀ may be a minimum γ value (γ₀ has been found empirically to be 0.6) and K_{G} may be a user defined coefficient Typically K_{G} may be close to 1.0. For dark images, Y(Hₘₐₓ) may be below Y_{D} and thus, the ratio of

$$\frac{Y ( {H}_{max} )}{{Y}_{max}}$$

may be quite small. When added to γ₀ of 0.6, and using Y_{D} of 0.3 as in the example hereinabove, the results is a range of γ_{D} for the dark images of 0.6<γ_{D}<0.9. For light images, Y(Hₘₐₓ) may be above Y_{L} and thus, the ratio of

$$\frac{Y ( {H}_{max} )}{{Y}_{max}}$$

may be quite large. When added to γ_{D} of 0.6 and using Y_{L} of 0.7, the results is a range of γ_{L} for the light images of 1.3<γ_{L}<1.6 (for K_{G}=1).

There are also pictures with complicated light distributions. For example, a picture might have a distribution Q_{DL} which might have a wide dark area and a small light area Another picture might have a distribution Q_{LD} with a wide light area and a small dark area. Similarly, there may be other distributions defined, such as dark/normal (Q_{DN}), normal/dark (Q_{ND}), light/normal (Q_{LN}) and normal/light (Q_{NL}).

A picture may be considered to have the distribution Q_{DL} if the following conditions hold:
If Q_{L}>[1−(Y_{N}/Y_{M})]Q_{M}
And Q_{D>}q_{D}*Q_{M}
where Y_{M} is the maximum allowable value of the intensity, such as 255.

Similarly, a picture may be considered of type Q_{LD} if. Q_{D}>(Y_{D}/Y_{M})*Q_{M} and Q_{L}>q_{L}*Q_{M}

where q_{D} and q_{L} is between 50% and 100%.

Similar conditions may be set for Q_{DN}, Q_{ND}, Q_{LN} and Q_{NL}.

For the complicated contrast distributions, such as those described hereinabove, the gamma response may be varied, with a different response for every portion, dark, normal, or light The gamma value for each portion may be calculated in accordance with the equations of paragraphs 30 and 32. For example, an exemplary gamma response for the dark/light distribution Q_{DL}, is presented in FIG. 6, to which reference is now briefly made. The gamma response may be defined as:

$${\{ {V}_{1} / {V}_{max} )}_{out} = \{ \begin{matrix}{( {V}_{1} / {V}_{max} )}_{in}^{{Y}_{D}} , & if 0 < ( {Y}_{1} / {Y}_{max} ) < ( {Y}_{0} / {Y}_{max} ) \\ {( {V}_{0} / {V}_{max} )}^{{Y}_{D}} + {[ ( {V}_{1} / {V}_{max} ) - {( {V}_{0} / {V}_{max} )}^{{Y}_{D}} ]}^{{Y}_{L}} , & otherwise\end{matrix}$$

where YₒY=H[Hₘₐₓ(Yᵢ)] and Vₒ is the relevant red (R), green (G) or blue (B) signal levels related to Yₒ, accordingly

Controller 64 may also determine the noise reduction coefficients Kₜ and Kγ. As is known in the art noise visibility is increased for dark and normal areas and is lower for light areas. Thus, controller 64 may generate a smaller multiplicative coefficient for dark images than for light images. One exemplary equation for generating noise reduction coefficients Kₜ and Kγ might be:

$${K}_{t} = {K}_{γ} = {γ}_{0} + \frac{Y ( {H}_{max} )}{{Y}_{max}} {K}_{F}$$

since the gamma correction curve increases from dark images to light images. K_{F} may be a coefficient defining a minimal noise reduction, which a user may define. Typically KF may be close to 1.0. In addition, noise reduction coefficients Kγ and Kₜ may be limited to no larger than 1.0.

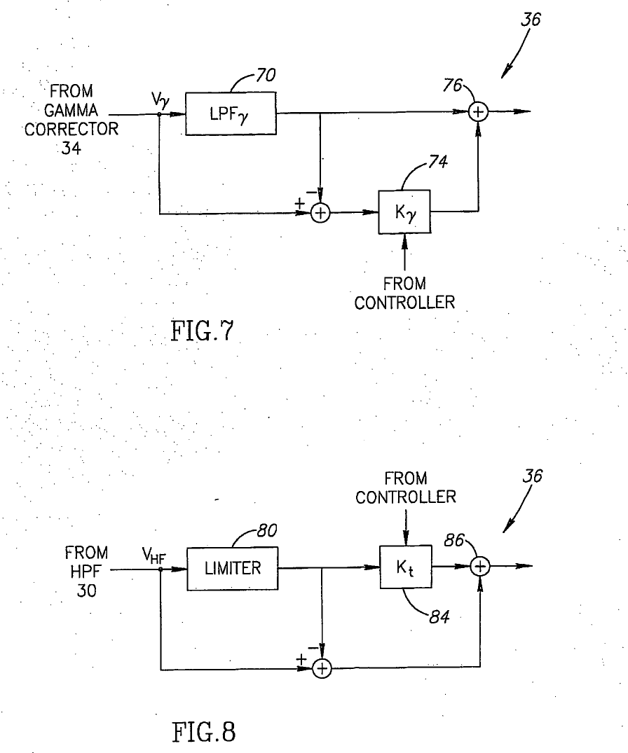

Reference is now made to FIG. 7, which illustrates an exemplary gamma noise reducer 36, operative on one color component. As gamma noise reducer 36 may be the same for all color components, only one will be described herein.

Noise reducer 36 may reduce high frequency noise in the signal from gamma corrector 34 and may comprise a low pass filter (LPFγ) 70, a subtractor 72, a multiplier 74 and a summer 76.

Low pass filter 70 may generate a low frequency component Vγ_{LF} from an input signal Vγ from gamma corrector 34. Subtractor 72 may subtract low frequency component Vγ_{LF} from the input signal Vγ, thereby producing a high frequency component Vγ_{HF} of input signal Vγ. The magnitude of high frequency component Vγ_{HF} may be changed, in multiplier 74, by noise reduction coefficient Kγ. The resultant high frequency noise reduced signal may be added to low frequency component Vγ_{LF} in adder 76, to generate the gamma noise reduced signal.

Reference is now made to FIG. 8, which illustrates an exemplary small details noise reducer 38. Noise reducer 38 may reduce texture noise in the high frequency color component signal produced by high pass filter 32 and may comprise a limiter 80, a subtractor 82, a multiplier 84 and an adder 86.

Limiter 80 may have a threshold level of 3-5 times the average noise level in the image and may generate a texture component signal Vₜ which may have low contrast detail data and noise (or grain). Subtractor 82 may remove texture component signal Vₜ from high frequency signal V_{HF} to generate other (contrast) components. The magnitude of texture component Vₜ may be changed, in multiplier 84, by noise reduction coefficient Kₜ. The resultant texture noise reduced signal may be added to the low contrast frequency component in adder 86, to generate the texture part noise reduced signal.

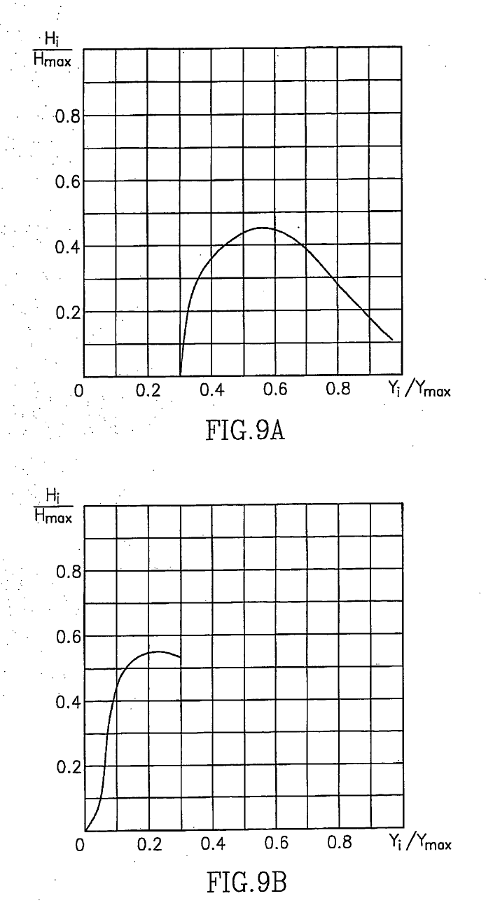

The present invention may also be utilized for images with a small dynamic range. For example, the histograms of two such images are shown in. FIGS. 9A and 9B, to which reference is now briefly made. FIG. 9A shows the histogram for an image with a ‘veil’ effect, which has no dark intensities. The intensities begin at Yᵢ/Yₘₐₓ=0.3. There are no intensities below that value. FIG. 9B, on the other hand, shows the histogram for an overly dark image, where the intensities end at Yᵢ/Yₘₐₓ=0.3. Neither image utilizes the full dynamic range of the camera or the film, and gamma correction, which functions over the entire dynamic range, will be unsuccessful as a result.

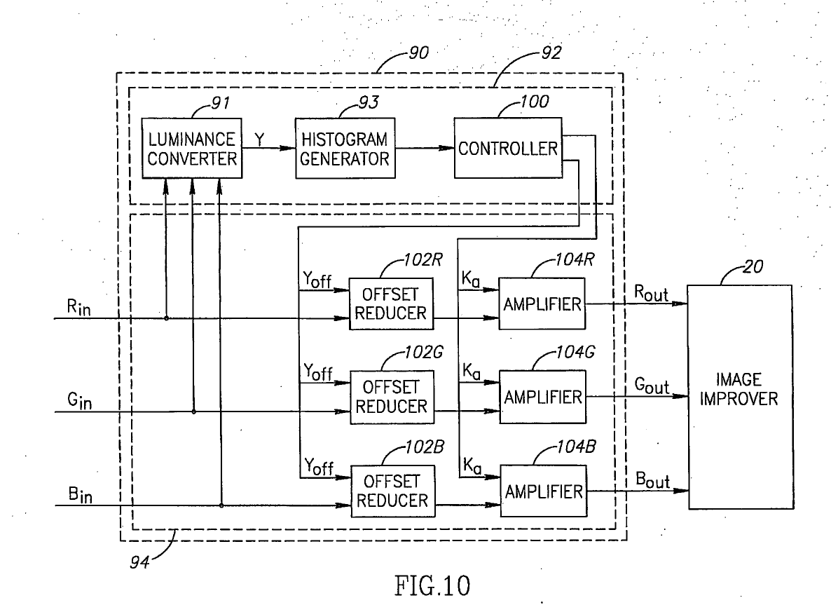

Reference is now made to FIG. 10, which illustrates a further embodiment of the present invention which may handle small dynamic range images. In this embodiment, a dynamic range corrector 90 may be added before image improver 20. Corrector 90 may determine how shrunk the dynamic range of said input image is and may shift, if necessary, and may amplify the dynamic range of the image to provide an output image with an appropriate dynamic range for image improver 20.

Corrector 90 may comprise an offset determiner 92 and a processor 94. Offset determiner 92 may generate the histogram of the intensities and may determine the extent that the intensities are shifted above the start of the dynamic range. The start typically is at a null-point. For example, for a dynamic range of 0-255, the null-point is Y=0. Determiner 92 may then determine the size of a shift Y_{off}, by which to correct the shift, if present, and the size of an amplification coefficient Kₐ by which to amplify the intensities. Processor 94 may then correct the shift using Y_{off} and may then amplify the possibly shifted intensities with a coefficient Kₐ.

To that end, determiner 92 may comprise luminance converter 91 (similar to luminance converter 42 of FIG. 2), which may convert the input RGB signal to a luminance Y signal, histogram generator 93 (similar to histogram generator 44 of FIG. 2), which may generate the histogram and a controller 100, which may determine a minimum value Y₁, and a maximum value Yₕ of the luminance intensities and which may determine the shift Y_{off} and coefficient Kₐ. therefrom Histogram generator 44 may generate the histogram using intensities rather than normalized intensities (i.e. Hᵢ rather than Hᵢ/Hₘₐₓ)

Controller 100 may determine whether or not the minimum value Y₁ is at a null-point, such as Y=0. In the example above, the dynamic range of 0-255, if the minimum value Y₁ is above 0, then there is an offset which must be fixed. Controller 100 may then set shift Y_{off} to the minimum value Y₁. Thus, if the minimum value Y₁ is 10, Y_{off} may become 10. If the minimum value Y₁ is at 0, then the shift Y_{off} may be set to 0.

If the maximum value Yₕ or the shifted maximum value (Yₕ-Y_{off}) is below the maximum value Yₘₐₓ, such as 255 in the example, the dynamic range is too small. Controller 100 may determine amplification coefficient Kₐ as follows:
Kₐ=D*Yₘₐₓ/(Yₕ−Y_{off})
where D may be less than 1 and may be a user selected value defining the amount of amplification that the user desires.

Processor 94 may comprise an offset reducer 102 and an amplifier 104 per color component (R, G or B). Each offset reducer 102R, 102G or 102B may subtract the shift value Y_{off} it receives from the input intensity Rᵢₙ, Gᵢₙ, or Bᵢₙ, respectively. Each amplifier 104 may multiply the signal it receives by coefficient Kₐ. The result may then be three output signals Rₒᵤₜ, Gₒᵤₜ and Bₒᵤₜ which may then be provided as an input signal to image improver 20.

In another embodiment of the present invention, the input signal to corrector 90 may be a luminance signal Y. In this embodiment, there is no luminance converter 91 and there is only one input channel, and thus, only one of each of offset reducer 102 and amplifier 104. Similarly, the image improver in this embodiment has no luminance converter 42 and only one input channel (and thus, only one of each of LPF 30 (FIG. 1), HPF 40, adaptive gamma corrector 34, gamma processed data adaptive noise reducer 36, small details adaptive noise reducer 38 and adder 40.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
analyzing an input image to generate correction parameters; and
performing a grey scale stretch on said image using said correction parameters with little or no visible change in the noise level of said image.

2. The method of claim 1 wherein said performing comprises gamma correcting said image using said correction parameters, wherein said gamma correcting is different for small details than for large details of said image.

3. The method of claim 1 wherein said input image is one of the following types of images: a still image, a digital image, a digitized image, a scanned image and one image of a video stream.

4. The method of claim 1 wherein said parameters comprise at least one of the following: gamma γ, a gamma noise reduction coefficient Kγ and a high frequency noise reduction coefficient Kₜ.

5. The method of claim I and wherein said analyzing comprises:
generating a histogram of the intensities of said image;
histogram analyzing to determine the type of said image; and
generating said parameters as a function of said type and said histogram.

6. The method of claim 5 and wherein said histogram analyzing comprises:
dividing said histogram into a multiplicity of sections;
determining which section comprises the greatest area of said histogram; and
determining the peak value of the histogram, Hₘₐₓ.

7. The method of claim 5 wherein said generating of said parameters comprises:
determining the value of gamma γ where γ is set to 1 for normal exposures and otherwise to
$$γ = {γ}_{0} + {K}_{G} \frac{Y ( {H}_{max} )}{{Y}_{max}} ,$$
where γ₀ is 0.6, Y(Hₘₐₓ) is the picture data intensity at Hₘₐₓ, and where Yₘₐₓ is the maximum allowable value of the intensity; and
determining the value of a high frequency noise reduction coefficient Kₜ and a gamma noise reduction coefficient Kγ where
$${K}_{t} = {K}_{γ} = {γ}_{0} + {K}_{F} \frac{Y ( {H}_{max} )}{{Y}_{max}} ,$$
and Kₜ and Kγ are limited to no larger than 1.0.

8. The method according to claim 2 wherein said gamma-correcting comprises:
separating said input image into a low-frequency channel and a high-frequency channel;
gamma-correcting the low-frequency channel using said picture parameters;
noise-reducing the output of said gamma-correcting; and
noise-reducing the high-frequency channel using said picture parameters.

9. The method according to claim 8 wherein said gamma correcting the low frequency channel comprises utilizing a value of gamma γ where γ is set to 1 for normal exposures and otherwise to
$$γ = {γ}_{0} + {K}_{G} \frac{Y ( {H}_{max} )}{{Y}_{max}} ,$$
where γ₀ is 0.6, Y(Hₘₐₓ) is the intensity at Hₘₐₓ, and where Yₘₐₓ is the maximum allowable value of the intensity.

10. The method according to claim 8 wherein said first noise reducing comprises utilizing a gamma noise reduction coefficient Kγ where
$${K}_{γ} = {γ}_{0} + {K}_{F} \frac{Y ( {H}_{max} )}{{Y}_{max}} ,$$
and Kγ is limited to no larger than 1.0.

11. The method according to claim 8 wherein said second noise reducing comprises utilizing a gamma noise reduction coefficient Kₜ, where
$${K}_{t} = {γ}_{0} + {K}_{F} \frac{Y ( {H}_{max} )}{{Y}_{max}} ,$$
and Kₜ is limited to no larger than 1.0.

12. The method according to claim 1 wherein said performing comprises correcting the dynamic range of said input image.

13. The method according to claim 12 and wherein said correcting comprises:
determining how shrunk the dynamic range of said input image is; and
amplifying the dynamic range of said image.

14. The method according to claim 13 and wherein said determining comprises analyzing a histogram of said image.

15. The method according to claim 13 and wherein said correcting also comprises, before said amplifying, shifting the data of said image to have a histogram starting at a null-point.

16. The method according to claim 13 and wherein said correcting also comprises, before said amplifying, shifting the data of said image so that a histogram starts at the beginning of a dynamic range.

17. The method according to claim 12 and wherein said input image is in one of the following formats: red, green, blue (RGB), and luminance Y and chrominance Cᵣ, C_{b} components.

18. A system comprising:
an image analyzer to analyze an input image to generate correction parameters; and
a grey scale stretcher to utilize said correction parameters to perform a grey scale stretch on said image with little or no visible change in the noise level of said image.

19. The system of claim 18 wherein said grey scale stretcher comprises a gamma corrector to gamma correct said image using said correction parameters, wherein said gamma corrector corrects differently for small details than for large details of said image.

20. The system of claim 18 wherein said input image is one of the following types of images: a still image, a digital image, a digitized image, a scanned image and one image of a video stream.

21. The system of claim 18 wherein said parameters comprise at least one of the following: gamma γ, a gamma noise reduction coefficient Kγ and a high frequency noise reduction coefficient Kₜ.

22. The system of claim 18 and wherein said image analyzer comprises:
a histogram generator to generate a histogram of the intensities of said image;
a histogram analyzer to analyze said histogram to determine the type of said image; and
a parameter generator to generate said parameters as a function of said type and said histogram.

23. The system of claim 22 and wherein said histogram analyzer comprises:
a divider to divide said histogram into a multiplicity of sections;
an area determiner to determine which section comprises the greatest area of said histogram; and
a peak determiner to determine the peak value of the histogram, Hₘₐₓ.

24. The system of claim 22 wherein said parameter generator comprises:
a gamma generator to determine the value of gamma γ where γ is set to 1 for normal exposures and otherwise to
$$γ = {γ}_{0} + {K}_{G} \frac{Y ( {H}_{max} )}{{Y}_{max}} ,$$
where γ₀ is 0.6, Y(Hₘₐₓ) is the picture data intensity at Hₘₐₓ, and where Yₘₐₓ is the maximum allowable value of the intensity; and
a coefficient determiner to determine the value of a high frequency noise reduction coefficient Kₜ and a gamma noise reduction coefficient Kγ where
$${K}_{t} = {K}_{γ} = {γ}_{0} + {K}_{F} \frac{Y ( {H}_{max} )}{{Y}_{max}} ,$$
and Kₜ and Kγ are limited to no larger than 1.0.

25. The system according to claim 19 wherein said gamma-corrector comprises:
a channel separator to separate said input image into a low-frequency channel and a high-frequency channel;
a low frequency gamma corrector to gamma-correct the low-frequency channel using said picture parameters;
a first noise reducer to reduce the noise in the output of said gamma-correcting; and
a second noise reducer to reduce the noise in the high-frequency channel using said picture parameters.

26. The system according to claim 25 wherein said low frequency gamma corrector utilizes a value of gamma γ where γ is set to 1 for normal exposures and otherwise to
$$γ = {γ}_{0} + {K}_{G} \frac{Y ( {H}_{max} )}{{Y}_{max}} ,$$
where γ₀ is 0.6, Y(Hₘₐₓ) is the intensity at Hₘₐₓ, and where Yₘₐₓ is the maximum allowable value of the intensity.

27. The system according to claim 25 wherein said first noise reducer utilizes a gamma noise reduction coefficient Kγ where
$${K}_{γ} = {γ}_{0} + {K}_{F} \frac{Y ( {H}_{max} )}{{Y}_{max}} ,$$
and Kγ is limited to no larger than 1.0.

28. The system according to claim 25 wherein said second noise reducer utilizes a gamma noise reduction coefficient Kₜ where
$${K}_{t} = {γ}_{0} + {K}_{F} \frac{Y ( {H}_{max} )}{{Y}_{max}} ,$$
and Kₜ is limited to no larger than 1.0.

29. The system according to claim 18 wherein said grey scale stretcher comprises a dynamic range corrector to correct the dynamic range of said input image.

30. The system according to claim 29 and wherein said dynamic range corrector comprises:
a controller to determine how shrunk the dynamic range of said input image is; and
an amplifier to amplify the dynamic range of said image using the output of said controller.

31. The system according to claim 30 and wherein said controller comprises an analyzer to analyze a histogram of said image.

32. The system according to claim 30 and wherein said corrector also comprises a shifter to shift the data of said image to have a histogram starting at a null-point.

33. The system according to claim 30 and wherein said corrector also comprises a shifter to shift the data of said image so that a histogram starts at the beginning of a dynamic range.

34. The system according to claim 29 and wherein said input image is in one of the following formats: red, green, blue (RGB), and luminance Y and chrominance Cr, C_{b} components.
